(19) United States
(12) Patent Application Publication
(10) Pub. No.: US 2024/0407613 A1
(43) Pub. Date: Dec. 12, 2024

(54) TOOL FITTING WITH FLUID BASED ELECTRICITY GENERATION AND ELECTRIC TOOL

(71) Applicant: HANGZHOU GREAT STAR INDUSTRIAL CO., LTD., Hangzhou (CN)

(72) Inventor: Lihua ZHOU, Hangzhou (CN)

(73) Assignee: HANGZHOU GREAT STAR INDUSTRIAL CO., LTD., Hangzhou (CN)

(21) Appl. No.: 18/809,377

(22) Filed: Aug. 20, 2024

Related U.S. Application Data
(63) Continuation-in-part of application No. PCT/CN2023/112870, filed on Aug. 14, 2023.

(30) Foreign Application Priority Data
Aug. 15, 2022 (CN) 202210976674.X

(51) Int. Cl. A47L 7/00; A47L 9/06; A47L 9/28; A47L 9/30; H02K 7/18

(52) U.S. Cl. CPC A47L 7/009; A47L 9/0693; A47L 9/2884; A47L 9/30; H02K 7/1823

(57) ABSTRACT

A tool fitting with fluid based electricity generation and an electric tool are provided. The tool fitting includes a housing and an auxiliary assembly, the housing is provided with a fluid port. The auxiliary assembly is installed on the housing. The auxiliary assembly includes a power generation unit and a function component, the function component is electrically connected to the power generation unit, and the power generation unit can covert kinetic energy to electric energy and supply power to the function component.

### CROSS-REFERENCE TO RELATED APPLICATIONS

This application is a continuation in part of international patent application No. PCT/CN2023/112870, filed on Aug. 14, 2023, which itself claims priority to Chinese patent application No. 202210976674.X, filed on Aug. 15, 2022, and titled “TOOL FITTING FOR USING PROCESS HAVING FLUID FLOWING AND ELECTRIC TOOL”. The contents of the above identified applications are hereby incorporated herein in their entireties by reference.

### TECHNICAL FIELD

The present disclosure relates to the field of electric tool, and in particular, to a tool fitting with fluid based electricity generation, and an electric tool.

### BACKGROUND

In traditional art, a tool fitting of an electric tool generally lacks some auxiliary functions (such as lighting, positioning, timing, etc.), and in some scenarios, it requires an additional auxiliary tool to facilitate use. For example, in poor ambient lighting or dark corner spaces, it requires auxiliary components that can supplement light to assist use of the electric tool.

However, additional lighting tools may cause inconvenience for operators, but if a lighting member is installed on the electric tool, additional power supply components need to be set up, or relatively long wires are required to connect the lighting members to the power supply unit of the electric tool.

### SUMMARY

According to various embodiments of the present disclosure, a tool fitting with fluid based electricity generation and an electric tool are provided.

The present disclosure provides a tool fitting with fluid based electricity generation. The tool fitting includes a housing and an auxiliary assembly. The housing includes a fluid port. The auxiliary assembly is installed on the housing. The auxiliary assembly includes a power generation unit and a function component, the function component is electrically connected to the power generation unit, the power generation unit is capable of converting kinetic energy into electrical energy under flowing of a fluid and supplying power to the function component.

In one embodiment of the present disclosure, the power generation unit includes a magnetic component and a movable component, the function component is electrically connected to the movable component, and the movable component is capable of moving and cutting magnetic induction lines generated by the magnetic component under flowing of the fluid.

In one embodiment of the present disclosure, the movable component includes a rotor and the rotor is capable of rotating and cutting the magnetic induction lines generated by the magnetic component under suction power of a vacuum cleaner.

In one embodiment of the present disclosure, the auxiliary assembly is movably installed on the housing to enable the auxiliary assembly to have a working state or a non-working state.

When the auxiliary assembly is in the working state, the movable component is capable of being driven to move and cutting the magnetic induction lines generated by the magnetic component under flowing of the fluid, the power generation unit is capable of supplying sufficient electricity to the function component to enable the function component to be in operation. When the auxiliary assembly is in the non-working state, the movable component is not capable of being driven to moving move by flowing of the fluid or the movable component is capable of being driven to move slowly by flowing of the fluid, the power generation unit is not capable of supplying sufficient electricity to the function component, and the function component is out of operation.

In one embodiment of the present application, the auxiliary assembly further includes a cover, the magnetic component and the movable component are both disposed in the cover, the function component is installed in the cover. The housing is provided with a first through hole, the cover is liftably installed on the first through hole, and the auxiliary assembly is capable to be at a first extreme position and a second extreme position. When the auxiliary assembly is the first extreme position, at least part of the auxiliary assembly is located in the housing to be in the working state. When the auxiliary assembly is at the second extreme position, at least part of the auxiliary assembly is located out of the housing to be in the non-working state.

In one embodiment of the present disclosure, the cover is provided with an air inlet and an air outlet, the air inlet is located on a side of the cover towards the fluid port, and the air outlet is located on a side of the cover away from the fluid port.

In one embodiment of the present disclosure, a ventilation portion and a sealing portion stacked up along a lifting direction of the cover are provided on a side of the cover towards the fluid port, and the air inlet is located on the ventilation portion. When the auxiliary assembly is in the working state, the ventilation portion and the sealing portion are located in the housing. When the auxiliary assembly is in the non-working state, the sealing portion is located in the housing, and the ventilation portion is capable of moving out of the housing through the first through hole.

In one embodiment of the present disclosure, the cover includes a first stopping ridge and a second stopping ridge, sizes of the first stopping ridge and the second stopping ridge are both greater than that of the first through hole. The first stopping ridge is located at a side of the cover towards the function component, the first stopping ridge is located outside the housing, the second stopping ridge is located between the ventilation portion and the sealing portion, and the second stopping ridge is located in the housing.

In one embodiment of the present disclosure, the tool fitting further includes a first switching component, and the first switching component is movably installed in the housing. The auxiliary assembly further includes a cover and a first elastic component. The magnetic component and the movable component are both disposed in the housing. The function component is installed on the cover. The cover is provided with a first abutting block protruding from the cover. The first elastic component is elastic along the lifting direction, and the first elastic component abuts against the first abutting block.

The first elastic component is capable of enabling the auxiliary assembly to have a tendency to switch to the working state, the first switching component is configured to enable the auxiliary assembly to be positioned in the non-working state and give way when the auxiliary assembly is switched to the working state. Alternatively, the first elastic component is capable of enabling the auxiliary assembly to have a tendency to switch to the non-working state, the first switching component is configured to enable the auxiliary assembly to be positioned in the working state and give way when the auxiliary assembly is switched to the non-working state.

In one embodiment of the present disclosure, the tool fitting further includes two guiding seats. The two guiding seats are fixed on two sidewalls of the housing opposite to each other, respectively. The two guiding seats protrude inwards the tool fitting. Two accommodating grooves are formed between the two guiding seats and the housing. A side of each of the two guiding seats towards inside the tool fitting is provided an avoidance slot along the lifting direction of the cover. The first elastic component and the first abutting block are both set as two. Two first abutting blocks protrude from two sides of the cover, respectively. The two first abutting blocks are inserted into the two accommodating grooves from the avoidance slot. The two first elastic components are accommodated in the accommodating groove. Each of the two first elastic components corresponds to one of the two first abutting blocks.

In one embodiment of the present disclosure, the tool fitting further includes a second elastic component. A second abutting block protrudes from an outer wall of the housing. The second elastic component is disposed between the second abutting block and the first switching component. The first switching component is slidably installed on the second abutting block and capable of being in contact with or separated from the cover. An incline angle is defined between a sliding direction of the first switching component and the lifting direction of the cover. The second elastic component is capable of exerting an elastic force to the first switching component, such that the first switching component has a tendency to abut against the cover continuously.

In one embodiment of the present disclosure, the auxiliary assembly further includes a cover, the magnetic component and the movable component are disposed in the cover, and the function component is installed in the cover. The housing is provided with a first through hole, the housing is rotatably installed on the first through hole, and the auxiliary assembly is capable to be at a third extreme position and a fourth extreme position. When the auxiliary assembly is at the third extreme position, at least part of the auxiliary assembly is located in the housing to be in the working state. When the auxiliary assembly is at the fourth extreme position, at least part of the auxiliary assembly is located out of the housing to be in the non-working state.

In one embodiment of the present application, the tool fitting further includes a second switching component. The second switching component is movably installed on the housing. The auxiliary assembly further includes a third elastic component, and the third elastic component abuts against the cover and the second switching component.

The third elastic component is capable of enabling the auxiliary assembly to have a tendency to switch to the working state. The second switching component is configured to enable the auxiliary assembly to be positioned in the non-working state and give way when the auxiliary assembly is switched to the working state. Alternatively, the third elastic component is capable of enabling the auxiliary assembly to have a tendency to switch to the non-working state, and the second switching component is configured to enable the auxiliary assembly to be positioned in the working state and give way when the auxiliary assembly is switched to the non-working state.

In one embodiment of the present disclosure, the tool fitting further includes a second elastic component. The second abutting block protrudes from an outer wall of the housing. The second elastic component is provided between the second abutting block and the second switching component. The second switching component is slidably installed on the second abutting block and capable of being in contact with or separated from the cover. The second elastic component is capable of exerting an elastic force to the second switching component to enable the second switching component to have a tendency to abut against the cover continuously.

In one embodiment of the present disclosure, the cover is provided with an air inlet and an air outlet, the air inlet is located on a side of the cover towards the fluid port, and the air outlet is located on a side of the cover away from the fluid port. In another embodiment, a rotation range of the cover relative to the housing is in a range of 15° to 90°.

In one embodiment of the present disclosure, the auxiliary assembly is a lighting assembly and the function component is a lighting member. The lighting assembly is movably installed on the housing, such that the lighting assembly has the working state and the non-working state.

When the lighting assembly is in the working state, the movable component is capable of being driven to move and cutting the magnetic lines generated by the magnetic component under flowing of the fluid, the power generation unit is capable of supplying the sufficient electricity to the lighting member to enable the lighting member to light.

When the lighting assembly is in the non-working state, the movable component is not capable of being driven to move by flowing of the fluid, or the movable component is capable of being driven to move slowly under flowing of the fluid, and the power generation unit is not capable of supplying sufficient electricity to the lighting member, such that the lighting member is not able to light.

In one embodiment of the present disclosure, the auxiliary assembly is detachably connected to the housing.

In one embodiment of the present disclosure, the auxiliary assembly further includes a cover, the cover is fixedly on the cover, the cover is provided with an air inlet and an air outlet, the magnetic component and the movable component are both provided in the cover, and the function component is installed in the housing.

In one embodiment of the present disclosure, the auxiliary assembly further includes a dust cover, and the dust cover is disposed on a side of the cover towards the fluid port. The air inlet is located on a side of the cover towards the fluid port, and the air outlet is located on a side surface of the cover.

In one embodiment of the present disclosure, a ventilation portion and a sealing portion are provided on a side of the cover towards the fluid port, the sealing portion is disposed in the fluid port, and the ventilation portion is disposed outside the housing. The air outlet is located on a side of the fluid port and/or a side surface of the cover. Alternatively, the cover includes a convex portion and a main portion fitting with each other, the convex portion is disposed outside the housing, the main portion is disposed in the housing, the air inlet is located on the convex portion, and the air outlet is located on a side of the main portion away from the fluid port or a side surface of the main portion.

In one embodiment of the present disclosure, the rotor is disposed on a side of the magnetic component towards the fluid port. Alternatively, the rotor is disposed on a side of the magnetic component away from the fluid port.

In one embodiment of the present disclosure, the tool fitting further includes an energy storage component and the energy storage component is electrically connected to the function component for supplying power to the function component.

In one embodiment of the present disclosure, the energy storage component is further electrically connected to the power generation unit and capable of storing electrical energy converted by the power generation unit to supply power to the function component.

In one embodiment of the present disclosure, the energy storage component is detachably connected to the housing. Alternatively, the energy storage component is a disposable battery or a rechargeable battery.

The present disclosure further provides an electric tool. The electric tool includes above tool fitting with fluid based electricity generation.

Details of one or more embodiments of this application are presented in the attached drawings and descriptions below. And other features, purposes and advantages of this application will become apparent from the description, drawings and claims.

### BRIEF DESCRIPTION OF THE DRAWINGS

For a better description and illustration of embodiments and/or examples of those disclosures disclosed herein, reference may be made to one or more attached drawings. Additional details or examples used to describe the drawings should not be considered as limiting the scope of any of the disclosed disclosures, currently described embodiments and/or examples, and currently understood best modes of these disclosures.

FIG. 1 is a schematic diagram of a dust suction head of some embodiments in the present disclosure.

FIG. 2 is a schematic diagram of the dust suction head in another view in FIG. 1.

FIG. 3 is a top view of the dust suction head in FIG. 1.

FIG. 4 is a cross-sectional schematic view of the dust suction head along A-A line in FIG. 3.

FIG. 5 is a cross-sectional schematic view of the dust suction head along B-B line in FIG. 3.

FIG. 6 is a schematic diagram of a housing in FIG. 1.

FIG. 7 is a schematic diagram of a lighting assembly in FIG. 1.

FIG. 8 is a schematic diagram of a dust suction head of some embodiments in the present disclosure.

FIG. 9 is a top view of the dust suction head in FIG. 8.

FIG. 10 is a cross-sectional schematic view of the dust suction head along C-C line in FIG. 9.

FIG. 11 is a cross-sectional schematic view of the dust suction head along D-D line in FIG. 9.

FIG. 12 is a schematic diagram of a lighting assembly in FIG. 8.

FIG. 13 is a schematic diagram of the lighting assembly in another view in FIG. 12.

FIG. 14 is a schematic diagram of a dust suction head of some embodiments in the present disclosure.

FIG. 15 is a schematic diagram of the dust suction head in another view in FIG. 14.

FIG. 16 is a top view of the dust suction head in FIG. 14.

FIG. 17 is a cross-sectional schematic view of the dust suction head along E-E line in FIG. 16.

FIG. 18 is a cross-sectional schematic view of the dust suction head along F-F line in FIG. 16.

FIG. 19 is a schematic diagram of a lighting assembly in FIG. 14.

FIG. 20 is a schematic diagram of the lighting assembly in another view in FIG. 19.

FIG. 21 is a schematic diagram of the lighting assembly in another view in FIG. 19.

FIG. 22 is a schematic diagram of a dust suction head of some embodiments in the present disclosure.

FIG. 23 is an exploded diagram of the dust suction head in FIG. 22.

FIG. 24 is a schematic diagram of the dust suction head in another view in FIG. 22.

FIG. 25 is a cross-sectional schematic view of the dust suction head along N-N line in FIG. 24.

FIG. 26 is a cross-sectional schematic view of a dust suction head of some embodiments in the present disclosure.

FIG. 27 is a schematic diagram of a dust suction head at a first extreme position of some embodiments in the present disclosure.

FIG. 28 is a top view of the dust suction head in FIG. 27.

FIG. 29 is a cross-sectional schematic view of the dust suction head along G-G line in FIG. 28.

FIG. 30 is a cross-sectional schematic view of the dust suction head along H-H line in FIG. 29.

FIG. 31 is a partial enlargement view of portion X in FIG. 30.

FIG. 32 is a schematic diagram of a lighting assembly in FIG. 27.

FIG. 33 is a schematic diagram of the lighting assembly in another view in FIG. 32.

FIG. 34 is a top view of a part of the dust suction head in FIG. 27.

FIG. 35 is a cross-sectional schematic view of the dust suction head along I-I line in FIG. 34.

FIG. 36 is a schematic diagram of a part of the dust suction head in FIG. 27.

FIG. 37 is a schematic diagram of a dust suction head at a second extreme position of some embodiments in the present disclosure.

FIG. 38 is a top view of the dust suction head in FIG. 37.

FIG. 39 is a cross-sectional schematic view of the dust suction head along J-J line in FIG. 38.

FIG. 40 is a cross-sectional schematic view of the dust suction head along K-K line in FIG. 38.

FIG. 41 is a schematic diagram of a dust suction head of some embodiments in the present disclosure.

FIG. 42 is a schematic diagram of a dust suction head on a third extreme position of some embodiments.

FIG. 43 is a schematic diagram of the dust suction head in another view in FIG. 42.

FIG. 44 is a right view of the dust suction head in FIG. 42.

FIG. 45 is a top view of the dust suction head in FIG. 42.

FIG. 46 is a cross-sectional schematic view of the dust suction head along L-L line in FIG. 45.

FIG. 47 is a schematic diagram of a lighting assembly in FIG. 42.

FIG. 48 is a schematic diagram of the lighting assembly in another view in FIG. 47.

FIG. 49 is a schematic diagram of a dust suction head at a fourth extreme position of some embodiments in the present disclosure.

FIG. 50 is a schematic diagram of the dust suction head in another view in FIG. 49.

FIG. 51 is a right view of the dust suction head in FIG. 49.

FIG. 52 is a top view of the dust suction head in FIG. 49.

FIG. 53 is a cross-sectional schematic view of the dust suction head along M-M line in FIG. 52.

FIG. 54 is a schematic diagram of a dust suction head of some embodiments in the present disclosure.

FIG. 55 is a schematic diagram of a part of the dust suction head in FIG. 54.

FIG. 56 is a schematic diagram of an electric tool of some embodiments in the present disclosure.

Reference signs are as follows.

100 represents a dust suction head; 101 represents a dust suction channel; 1001 represent an auxiliary assembly; 1002 represents a function component; 10 represents a housing; 11 represents a fluid port; 12 represents a connection opening; 13 represents a first through hole; 14 represents a bending portion; 15 represents a second abutting block; 16 represents a first snapping portion; 17 represents a second snapping portion; 20 represents a lighting assembly; 21 represents a cover; 211 represents an air inlet; 212 represents an air outlet; 213 represents a ventilation portion; 214 represent a sealing portion; 215 represents a first stopping ridge; 216 represents a second stopping ridge; 217 represents a first abutting block; 218 represents a convex portion; 219 represents a main portion; 20A represents a power generation unit; 22 represents a magnetic component; 23 represents a movable component; 231 represents a rotor; 24 represents a lighting member; 25 represents a first elastic component; 27 represents a dust cover; 31 represents a first switching component; 32 represents a second elastic component; 41 represents a second switching component; 42 represents a third elastic component; 50 represents a guiding seat; 51 represents an accommodating groove; 52 represents an avoidance slot; 60 represents an energy storage component; 70 represents a sealing cover; 71 represents an elastic snapping component; a represents a lifting direction of a cover; β represents a rotation direction of a cover; y represents a sliding direction; 8 represents a rotation direction of a movable component; 200 represents a tool fitting; 300 represents an electric tool; I represents a first extreme position; II represents a second extreme position; III represents a third extreme position; and IV represents a fourth extreme position.

### DETAILED DESCRIPTION

The following will provide a clear and complete description of the technical solution in the embodiments of the present disclosure, in communication with the accompanying drawings. Obviously, the described embodiments are only a part of the embodiments of the present disclosure, not all of them. Based on the embodiments in the present disclosure, all other embodiments obtained by ordinary skill in this art without creative labor fall within the scope of protection of the present disclosure.

It should be noted that, when a component is considered “connected to” another component, it can be directly fixed to another component or there may be a centered component present simultaneously. When a component is considered “set on” another component, it can be directly set on another component or there may be a centered component present simultaneously. When a component is considered “fixed to” another component, it can be directly fixed to another component or there may be a centered component present simultaneously.

Unless otherwise defined, all technical and scientific terms used in this article have the same meanings as those commonly understood by those skilled in the technical field of the present disclosure. The terms used in the specification of the present disclosure are only for the purpose of describing specific embodiments and are not intended to limit the present disclosure. The term “or/and” used in this article includes any and all combinations of one or more related listed items.

In traditional art, a tool fitting of an electric tool generally lack some auxiliary functions (such as lighting, positioning, timing, etc.), and in some scenarios, it requires an additional auxiliary tool to facilitate use. For example, in poor ambient lighting or dark corner spaces, it requires auxiliary components that can supplement light to assist using of the electric tool.

However, additional lighting tools are inconvenient for the operators to operate, but if lighting members are installed on the electric tool, additional power supply component is required, or relatively long wires are required to connect the lighting members to the power supply unit of the electric tool.

Based on above problem, the present disclosure provides a tool fitting 200 for a using process having a fluid flowing and an electric tool 300, in which the tool fitting 200 is a part of the electric tool 300. The tool fitting 200 can be detachably connected to, fixedly connected to, or integrated with other structures of the electric tool 300.

The tool fitting 200 includes a housing 10 and an auxiliary assembly 1001. The housing 10 is provided with a fluid port 11. The auxiliary assembly 1001 is installed on the housing 10. The auxiliary assembly 1001 includes a power generation unit 20A and a function component 1002. The function component 1002 is electrically connected to the power generation unit 20A, and the power generation unit 20A is capable of converting kinetic energy into electrical energy under flowing of a fluid and supplying power to the function component 1002.

By a requirement of the tool fitting 200, the auxiliary assembly 1001 can be a lighting assembly 20, a positioning assembly, a timing assembly, a disinfection and sterilization component, and so on.

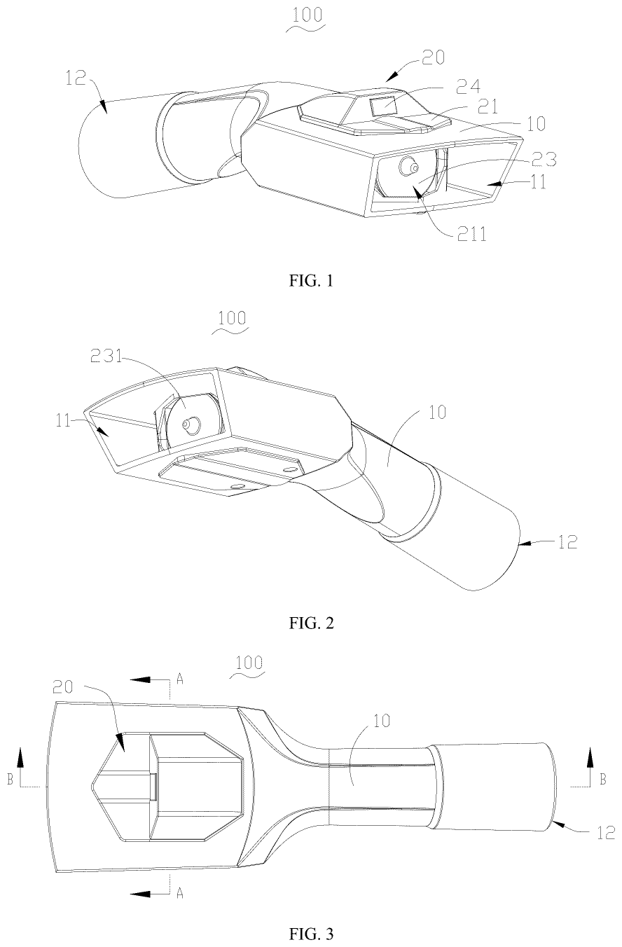

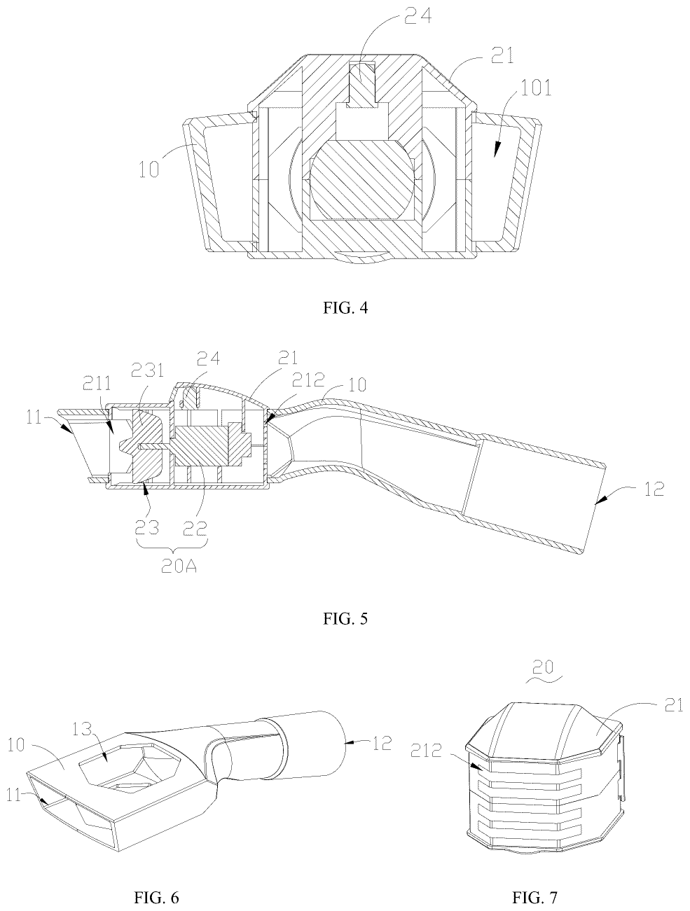

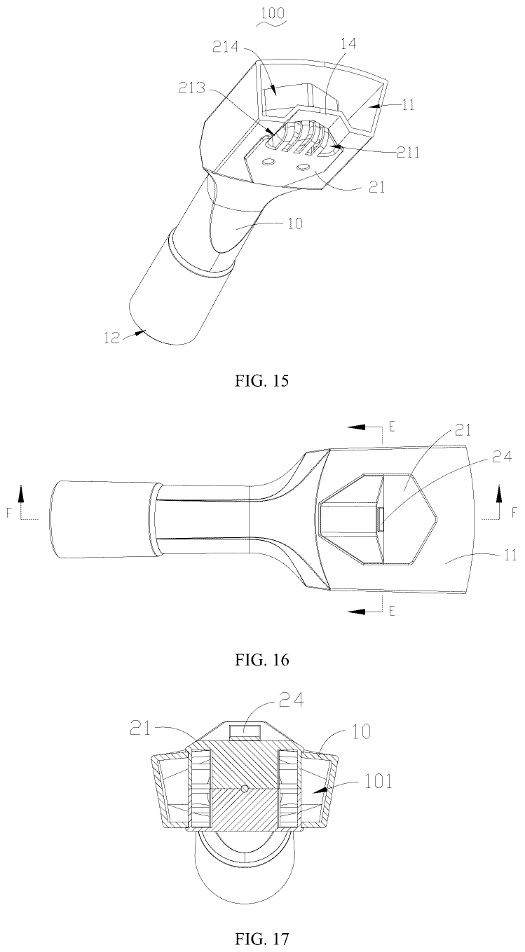

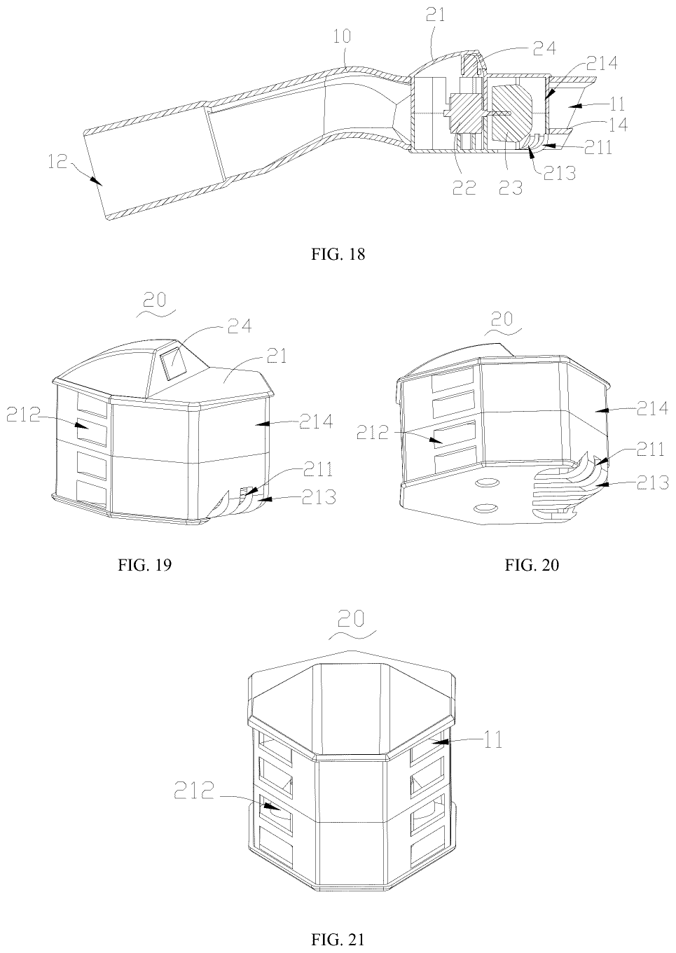

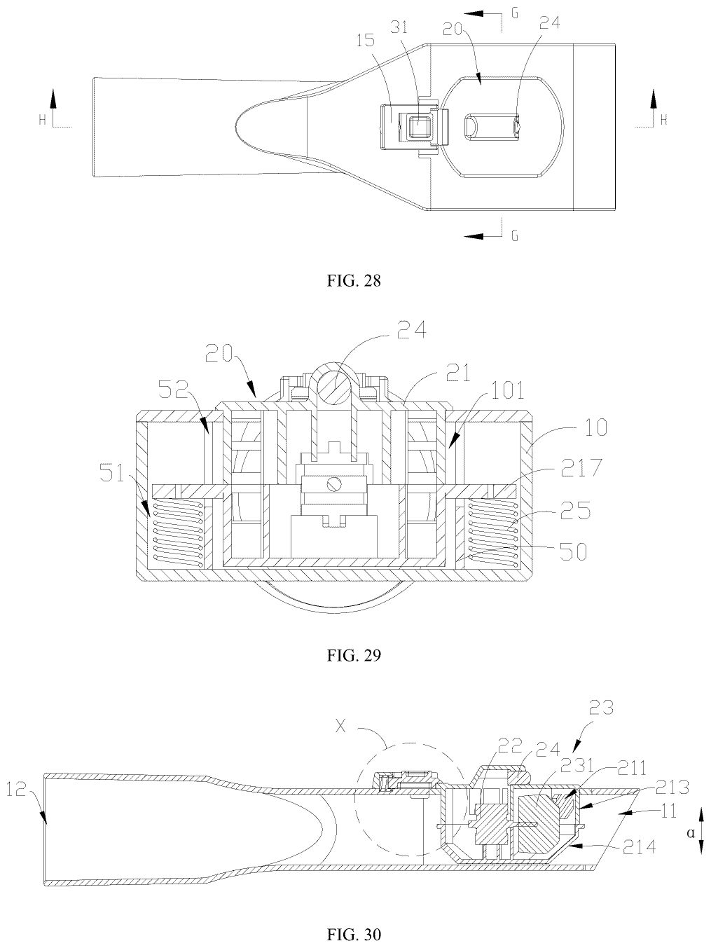

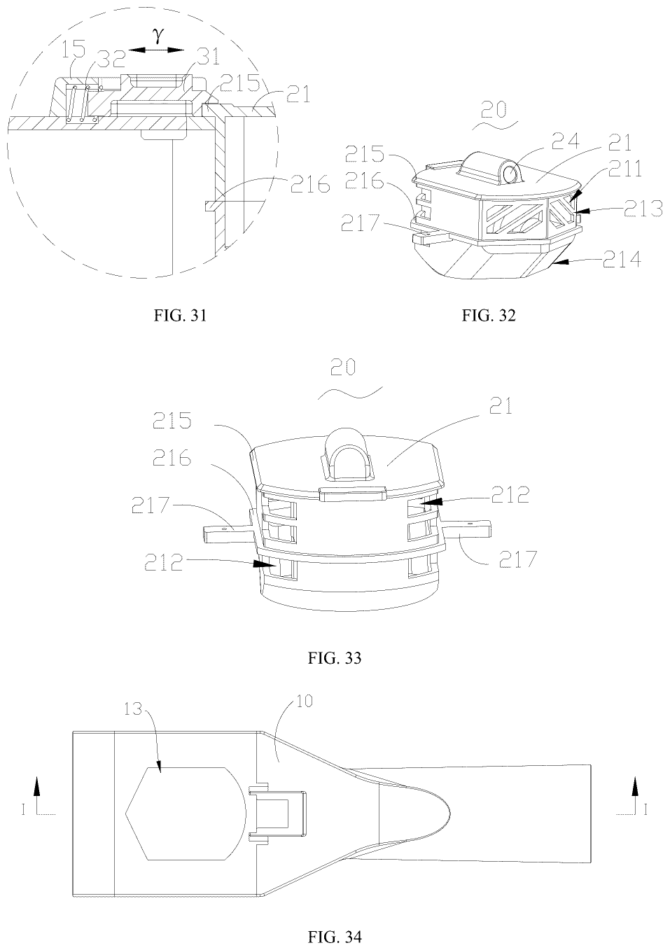

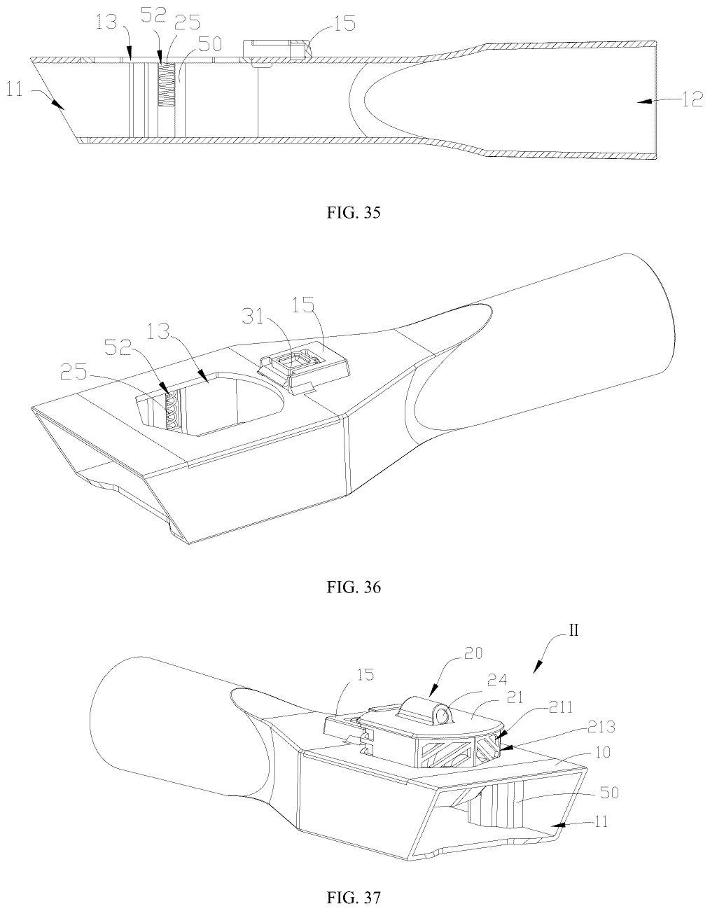

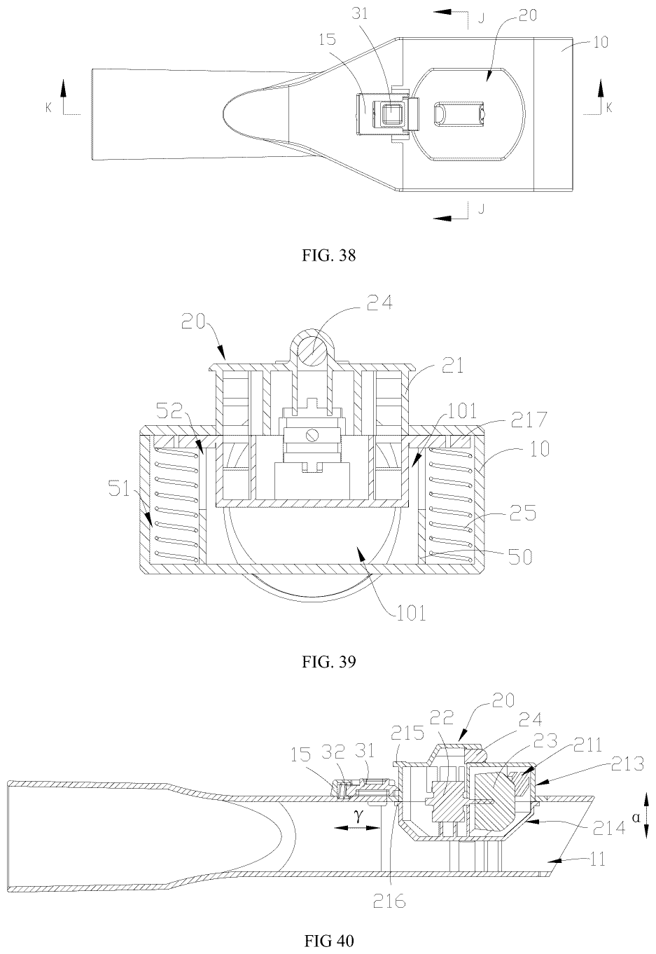

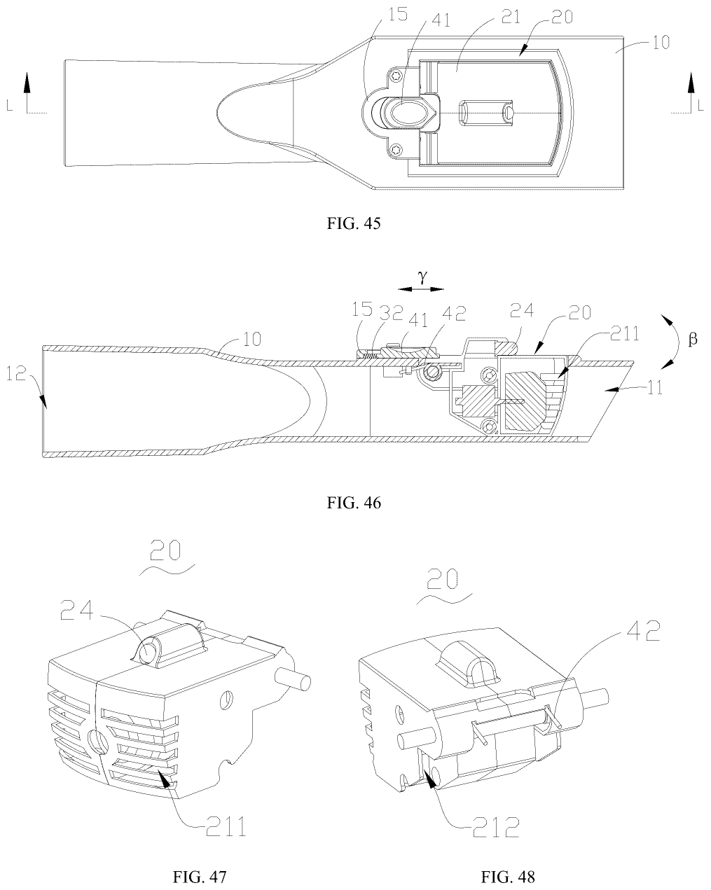

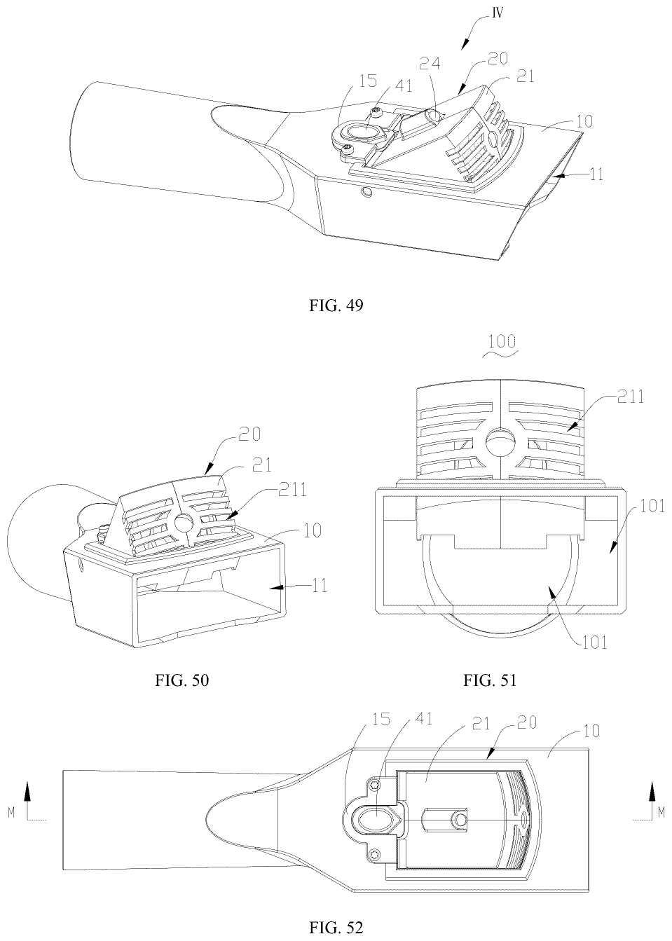

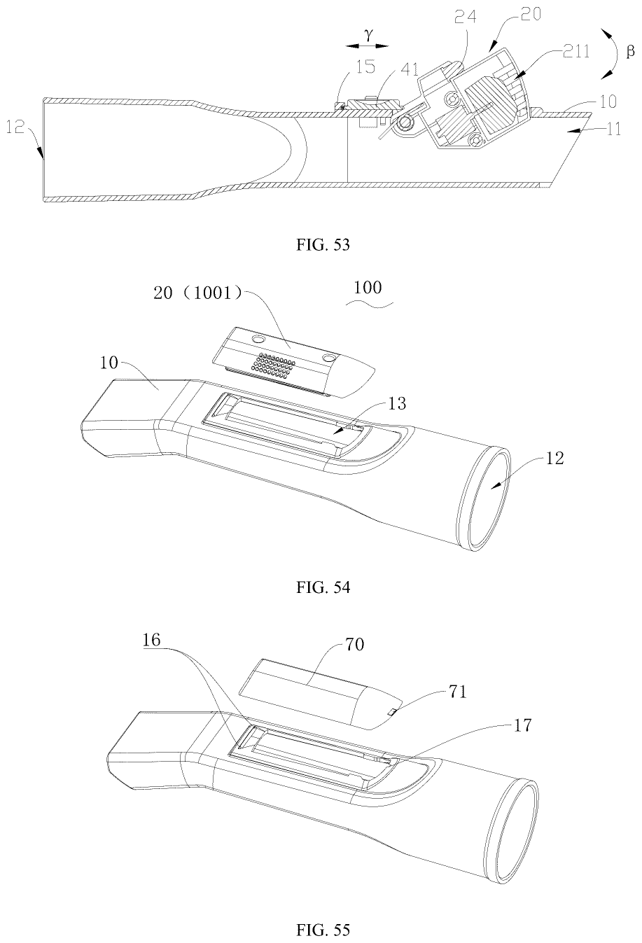

For example, taking the tool fitting 200 being a dust suction head 100 as an example, referring to FIGS. 1 to 54, the present disclosure provides a dust suction head 100 configured to be used in the electric tool 300 such as a vacuum cleaner. In particular, the vacuum cleaner (not shown) includes a vacuum cleaner body (not shown). The dust suction head 100 is capable of being fixed on or separated from the vacuum cleaner body. The vacuum cleaner body can generate a suction force and transfer the suction force to the dust suction head 100.

The electric tool 300 is not limited by the vacuum cleaner, and the tool fitting 200 is not limited by the dust suction head 100. For example, the electric tool 300 can be an air blower, and the tool fitting 200 can be a structure located on an air outlet of the electric tool 300. Alternatively, an electric tool 300 can be an electric tool 300 having liquid (such as water or oil) flowing during use, as long as flowing of the fluid can drive the power generation unit 20A to generate electricity. In addition, the dust suction head 100 in the drawings is merely illustrated as an example, and the other forms of dust suction heads, such as a dust suction head with bristles, flat mouthed vacuum cleaners, or long mouthed vacuum cleaners can be used.

Referring to FIGS. 1 to 2, the dust suction head 100 includes a housing 10. The housing 10 is provided with a fluid port 11, an end of the housing 10 away from the fluid port 11 is provided with a connection opening 12, and the connection opening 12 is configured to be connected to the dust suction head 100.

For example, taking a lacked auxiliary function is a light source as an example, in the traditional art, the dust suction head of the vacuum cleaner usually does not have a light source, the vacuum cleaner may be used in poor ambient lighting or dark corner spaces, and it requires additional light to facilitate to cleaning. However, if a lighting member is provided on the dust suction head, a power supply component is required or a relatively long wire is required to connect the lighting member to a power supply unit of the vacuum cleaner.

If a power supply component is provided on the dust suction head, the electricity of the power supply component and a situation of timely charging or replacing a battery when the power supply element is no power are required to be considered. If the relatively long wire is disposed on the dust suction head, a design of the housing 10 is required to change to fix the wire, and a detachment of the dust suction head will be affected.

In addition, the lighting member is generally required to be singly provided with a switch, if the lighting member links the switch of the vacuum cleaner, which requires to be controlled by a circuit or a control unit, thereby increasing a production cost of the vacuum cleaner and the dust suction head.

In the present disclosure, referring to FIGS. 1 to 7, the dust suction head 100 provided by the present disclosure further includes a lighting assembly 20. The lighting assembly 20 is installed on the housing 10. The lighting assembly 20 includes a power generation unit 20A and a lighting member 24. The lighting member 24 is electrically connected to the power generation unit 20A. The power generation unit 20A is capable of generating electricity under a suction force of the vacuum cleaner and supplying power to the lighting member 24. In other words, in illustrated embodiments, the auxiliary assembly 1001 is configured as the lighting assembly 20, and the function component 1002 is configured as the lighting member 24.

In the present disclosure, the lighting assembly 20 supplies kinetic energy to the power generation unit 20A by the suction force of the vacuum cleaner. The power generation unit 20A is capable of converting the kinetic energy into the electricity energy and supplying electricity to the lighting member 24, and no addition power source is required. In addition, in the present disclosure, the lighting member 24 is capable of linking with a switch of the vacuum cleaner. When the vacuum cleaner is in operation and the suction is generated, the fluid starts to flow, the power generation unit 20A is capable of generating power, and the lighting member 24 is capable of lighting. When the vacuum cleaner is out of operation and the suction force is not generated, the fluid stops flowing, and the power generation unit 20A stops generating the power, such that the lighting member 24 is closed.

In some embodiments, the power generation unit 20A includes a magnetic component 22 and a movable component 23. The lighting member 24 is electrically connected to the movable component 23, and the movable component 23 is capable of moving and cutting the magnetic induction lines generated by the magnetic component 22 under the suction force of the vacuum cleaner.

In particular, the movable component 23 includes a rotor 231, and the rotor 231 is capable of rotating and cutting the magnetic induction lines generated by the magnetic component 22. The movable component 23 can use other forms of movement such as linear motion, curved motion, or harmonic motion, as long as the movable component 23 can cut the magnetic induction lines and generate the electricity.

Furthermore, in the present disclosure, as long as the movable component 23 can cut the magnetic induction lines to generate current, a rotation direction of the movable component 23 is not limited. For example, the movable component 23 can cut the magnetic induction lines along X direction, Y direction or Z direction.

Moreover, the magnetic component 22 can be installed after the magnetic component 22 has magnetism or can be magnetized after being installed in the tool fitting 200. A magnetized method of the magnetic component 22 is not limited herein.

Furthermore, the rotor 231 can be a fan (not shown) to increase an area of cut magnetic induction lines, and can be other components, which is not limited herein.

The rotor 231 can be disposed on a side of the magnetic component 22 towards the fluid port 11 or a side of the magnetic component 22 away from the fluid port 11.

In some embodiment, the lighting member 24 uses a LED light, a power required of the LED light is small, the power generation unit 20A is easy to light the LED light, and a lighting effect of the LED is relatively great.

The lighting assembly 20 further includes a cover 21, the magnetic component 22 and the movable component 23 are both disposed in the cover 21, and the lighting member 24 is installed on the cover 21. A first through hole 13 is formed on the housing 10, and the cover 21 is installed on the first through hole 13. In other embodiments, the cover 21 is not required, the magnetic component 22, the movable component 23, and/or the lighting member 24 are installed by a support or other structures. Alternatively, one of the magnetic component 22 and the movable component 23 is installed in the cover 21, the other of the magnetic component 22 and the movable component 23 is located outside the cover 21, which is not limited herein.

In some embodiment, a first part of the cover 21 is located in a cavity of the housing 10, and the magnetic component 22 and the movable component 23 are both disposed in the first part of the cover 21. A second part of the cover 21 exposes outside the housing 10. The lighting member 24 is installed on the second part of the cover 21 located on outer side of the housing 10 and disposed towards the fluid port 11. By such arrangement, the lighting member 24 is not located on the fluid port 11, thereby preventing the lighting member 24 from absorbing dust to affect the lighting effect during use. The lighting member 24 can be disposed in an inner side of the housing 10, and the lighting member 24 facilitates to cleaning.

In the present disclosure, the cover 21 includes a first part and a second part. In other embodiments, the cover 21 can includes a plurality of sub-parts, which can be provided as required and is not limited herein. For example, the cover 21 includes a first part, a second part and a third part. The first part of the cover 21 is located in the cavity of the housing 10. The magnetic component 22 and the movable component 23 are both disposed in the first part of the cover 21. The second part and the third part of the cover 21 exposes outside the housing 10 through the first through hole 13. The lighting member 24 is installed on the second part or the third part of the cover 21 located outside the housing 10.

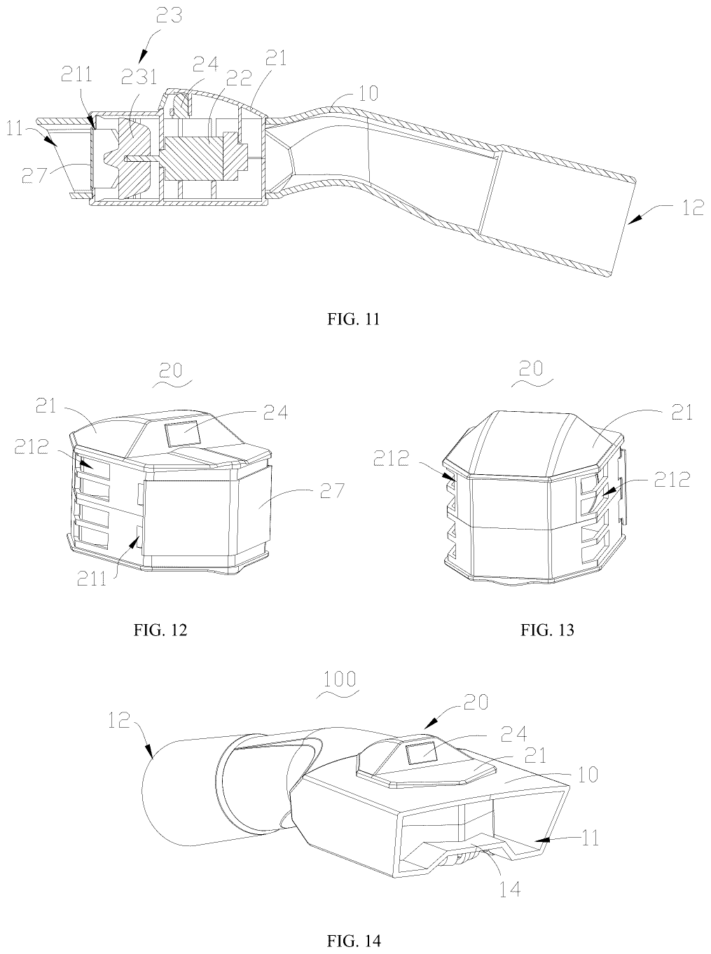

The cover 21 is provided with an air inlet 211 and an air outlet 212. When the vacuum cleaner is opened, the air of external environment enters the cover 21 through the air inlet 211 and leaves the cover 21 through the air outlet 212. In some embodiments, referring to FIGS. 1 and 7, the air inlet 211 is located on a side of the cover 21 towards the fluid port 11, and the air outlet 212 is located on a side of the cover 21 away from the cover 21. By such arrangement, the suction force generated from the vacuum cleaner can be greatly transferred to the movable component 23 to drive the movable component 23 to rotate and generate the electricity energy. In other embodiments, referring to FIGS. 12 and 13, the air inlet 211 is located on a side surface of the cover 21, and the air outlet 212 is located on a side surface of the cover 21 away from the fluid port 11. By such arrangement, it can supply sufficient electricity to the lighting member 24 and can avoid excessive dust to be sucked into the cover 21 due to a fast wind speed. The side surface of the cover 21 means other surfaces, except for a surface of the cover 21 towards the fluid port 11, the surface of the cover 21 away from the fluid port 11, and a surface of the cover 21 configured to install the lighting member 24.

Furthermore, a dust suction channel 101 is formed between at least one side surface of the cover 21 and an inner wall of the housing 10 for the dust to be sucked into the vacuum cleaner by the dust suction head 100.

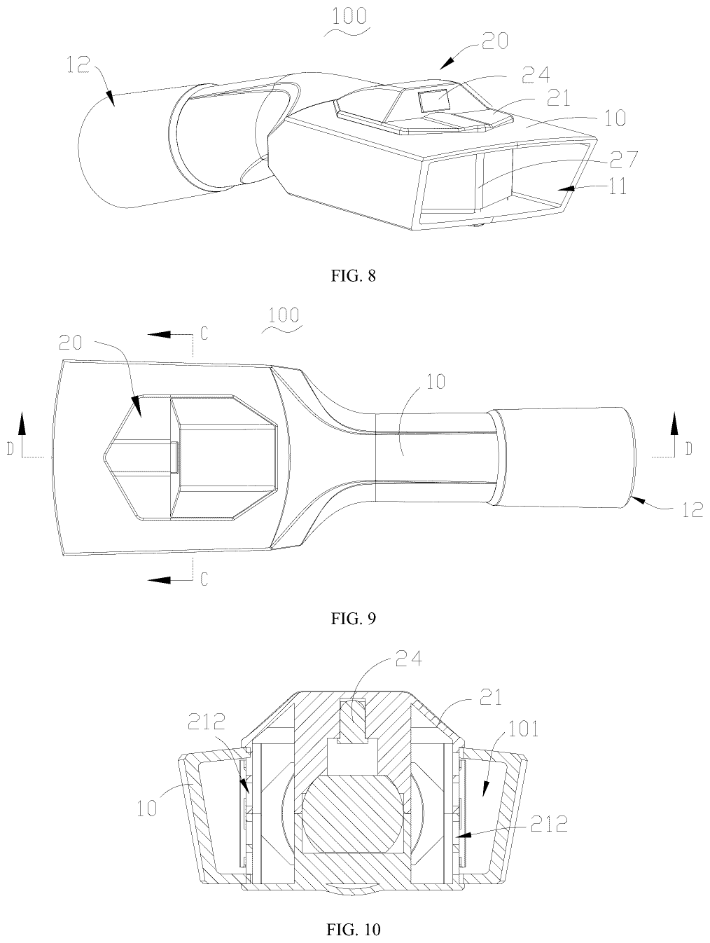

In some embodiments, referring to FIGS. 8 and 12, the lighting assembly 20 further includes a dust cover 27, and the dust cover 27 is disposed on the side of the cover 21 towards the fluid port 11. By such arrangement, it can significantly prevent the dust from entering the cover 21 to affect the movable component 23 to rotate.

Furthermore, the dust cover 27 can be inclined to the dust suction channel 101 to guide the dust to move.

Referring to FIG. 26, in some embodiments, the tool fitting 200 further includes an energy storage component 60. The energy storage component 60 is electrically connected to the function component 1002 to supply power to the function component 1002. That is, in the present embodiment, the energy storage component 60 is electrically connected to the lighting member 24 to supply power to the lighting member 24. By such arrangement, the energy storage component 60 can supply power to the function component 1002 anytime, such that operator can open the function component 1002 anytime. The energy storage component 60 can supply the power to the lighting member 24 anytime, such that the lighting member 24 can switch to the working state to provide a light source.

The energy storage component 60 can be a disposable battery or a rechargeable battery as required.

Furthermore, in some embodiments, the energy storage component 60 can be electrically connected to the power generation unit 20A to store electric energy converted by the energy storage component 20A and supply power to the function component 1002. By such arrangement, an excess electric energy converted by the power generation unit 20A can be stored to prevent energy from wasting.

Moreover, the energy storage component 60 can be movably installed on the housing 10. By such arrangement, the energy storage component 60 can be detached or replaced when the energy storage component 60 is damaged or aged.

Moreover, when the energy storage component 60 is the rechargeable battery, the energy storage component 60 can be charged by solar or wind energy, and the energy storage component 60 can be provided with a charging socket and be connected to external charging source for charging, which is not limited herein.

In some embodiments, such as a first embodiment, a second embodiment, a third embodiment, a fourth embodiment and a fifth embodiment, the lighting assembly 20 is fixedly on the housing 10 via the cover 21.

In particular, referring to FIGS. 1 to 7, in the first embodiment, the housing 10 is provided with a first through hole 13, the cover 21 is fixed on the first through hole 13, a first part of the cover 21 is located in the cavity of the housing 10, the rotor 231 and the magnetic component 22 are both located in the first part of the cover 21, and the rotor 231 is disposed on a side of the magnetic component 22 towards the fluid port 11. A second part of the cover 21 is located outside the housing 10, and the lighting member 24 is installed on the second part of the cover 21 and disposed towards the fluid port 11. A size of the first part of the cover 21 is greater than that of the second part of the cover 21. Alternatively, in other embodiments, the cover 21 can include a plurality of sub-parts, and the plurality of sub-parts can be adaptively disposed inside or outside of the housing 10, which is not limited herein. The air inlet 211 is located on a side of the cover 21 towards the fluid port 11, and the air outlet 212 is located on a side of the cover 21 away from the fluid port 11.

The air outlet 212 and the air inlet 211 can not only be located on a single surface, respectively, for example, the air outlet 212 located on the side of the cover 21 away from the fluid port 11 can extend to a side surface of the cover 21.

Referring to FIGS. 8 to 13, the second embodiment is substantially the same as the first embodiment, except that, in the second embodiment, a cover 21 is provided with two air outlet groups. The two air outlet groups are disposed on two opposite side surfaces of the cover 21, respectively, and each of the two air outlet groups includes at least one air outlet 212. Alternatively, the air outlet 212 located on a side surface of the cover 21 can extend to a side of the cover 21 away from the fluid port 11, which is not limited herein.

In addition, in the second embodiment, a dust cover 27 is disposed on an air inlet 211 to prevent the dust from entering the cover 21. The number of dust suction channel 101 is two. Two dust suction channels 101 are located on two side surface of the cover 21 opposite to each other, respectively. The dust cover 27 is in a V shape and inclined to the two dust suction channels 101, respectively.

Referring to FIGS. 14 to 21, the third embodiment is substantially the same as the first embodiment, expect that, in the third embodiment, a side of the cover 21 towards a fluid port 11 includes a ventilation portion 213 and a sealing portion 214, the sealing portion 214 is located in the fluid port 11, and the ventilation portion 213 is located out of the housing 10. The air inlet 211 is located on the ventilation portion 213, and the air outlet 212 is located on a side of the cover 21 away from the fluid port 11 and/or a side surface of the cover 21. The sealing portion 214 is in a plate shape. The sealing portion 214 is disposed in the fluid port 11 to prevent the dust from entering the cover 21.

Furthermore, the ventilation portion 213 is located on a side of the housing 10 away from the first through hole 13. That is, the ventilation portion 213 is located on a bottom of the housing 10. When the vacuum cleaner is opened, external air can enter the housing 10 from the air inlet 211 located on the bottom of the housing 10, then be collected to the dust suction channel 101 from the air outlet 212, and flow out of the connection opening 12 to drive the rotor 231 to rotate.

Furthermore, the housing 10 is provided with a bending portion 14 bending towards the fluid port 11, such that the ventilation portion 213 can not protrude from the housing 10 to prevent from increasing a size of a dust suction head 100.

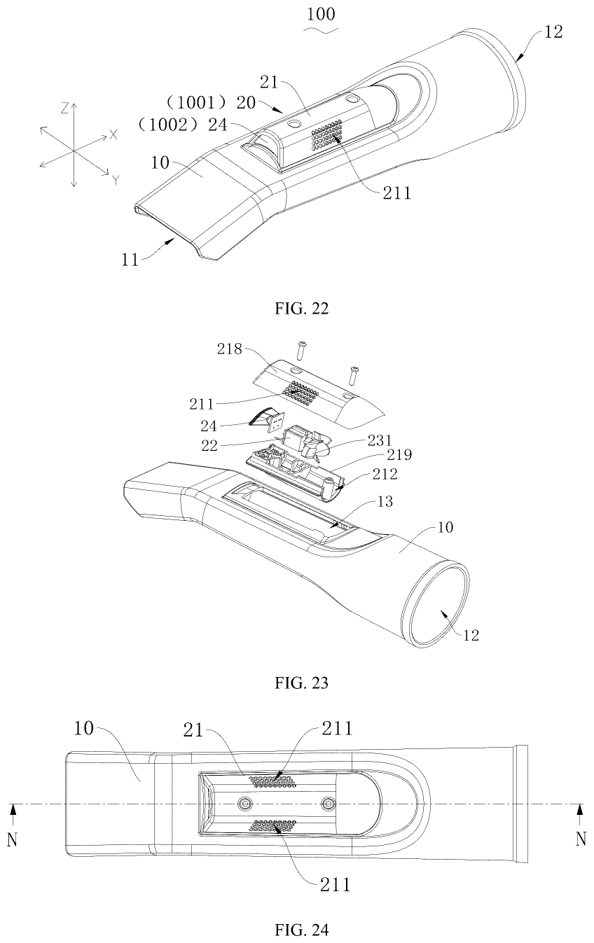

Referring to FIGS. 22 to 25, the fourth embodiment is substantially the same as the third embodiment, except that, in the fourth embodiment, a cover 21 includes a convex portion 218 and a main portion 219 fitting with each other, the convex portion 218 is located out of the housing 10, the main portion 219 is located in the housing 10, the main portion 219 is located in the housing 10, an air inlet 211 is located on the convex portion 218, and an air outlet 212 is located on a side of the main portion 219 away from a fluid port 11 or a side surface of the main portion 219.

In particular, along Z direction, the convex portion 218 protrudes from the first through hole 13 and is located out of the housing 10, and the main portion 219 is disposed in the housing 10 and located in the fluid port 11. In other words, the convex portion 218 is located on a top of the housing 10. When the vacuum cleaner is opened, external air can enter the housing 10 from the air inlet 211 located on the top of the housing 10, then be collected to a dust suction channel 101 from the air outlet 212, and flow out of a connection opening 12 to drive the rotor 231 to rotate.

Furthermore, the number of groups of the air inlet 211 is two, two groups of the air inlets 211 are located on two sides of the convex portion 218 opposite to each other. In particular, the two groups of the air inlets 211 are located on two sides of the convex portion 218 opposite to each other along Y direction.

For example, in the present embodiment, the rotor 231 is an impeller. The movable component 23 is disposed on a side of the magnetic component 22 away from the fluid port 11. By such arrangement, it can prevent the movable component 23 from directly being in contact with impurities such as dust and so on, to avoid jamming of the movable component 23.

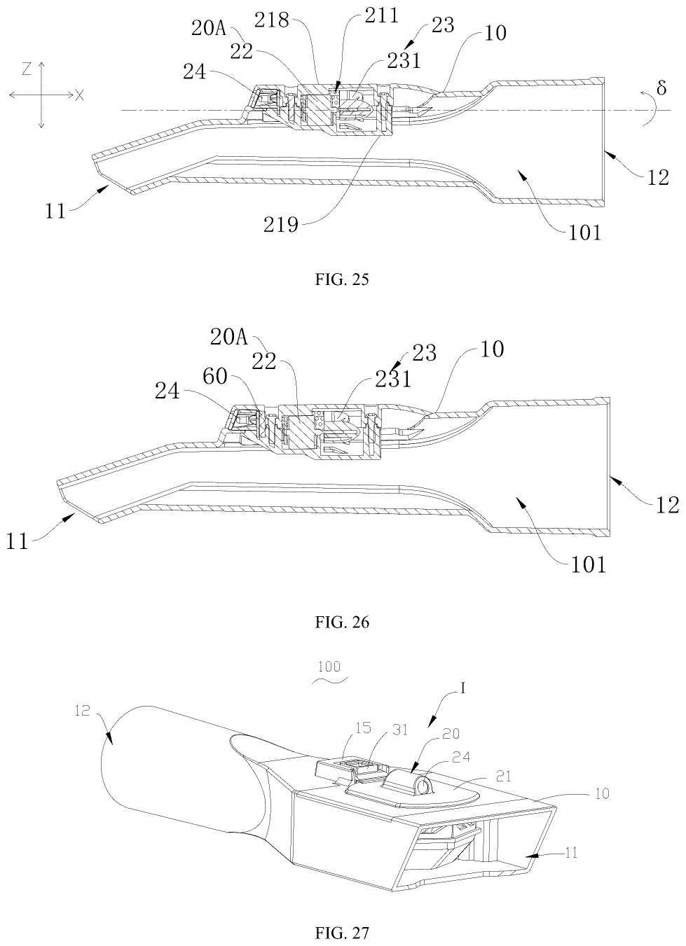

Referring to FIG. 25, in the present embodiment, the movable component 23, i.e., the rotor 231 rotates along a rotation axis 8 (i.e., a rotation direction). The movable component 23 can be directly connected to the magnetic component 22 or indirectly connected to the magnetic component 22 through a gear or other components. In other words, the movable component 23 can be directly driven or indirectly driven to rotate. In the present embodiment, the rotor 231 rotates along the X direction to cut the magnetic induction lines and generate current. In other embodiments, the rotor 231 can rotate along other directions to cut the magnetic induction lines, in which the other directions includes but not limited by the Z direction and the Y direction.

Referring to FIG. 26, the fifth embodiment is substantially the same as the fourth embodiment, except that, in the fifth embodiment, a vacuum cleaner 100 further includes an energy storage component 60. The energy storage component 60 is electrically connected to a power generation unit 20A and a function component 1002. The energy storage component 60 is configured to store electric energy converted by the power generation unit 20A to supply power to the function component 1002. By such arrangement, the energy storage component 60 can supply the power to the function component 1002 anytime, such that an operator can open the function component 1002 anytime. Furthermore, the energy storage component 60 can store the electric energy converted by the power generation unit 20A to prevent energy from wasting. In particular, in the present embodiment, the energy storage component 60 is electrically connected to a magnetic component 22 of the power generation unit 20A and a lighting member 24, after the rotor 231 of the power generation unit 20A cutting the magnetic induction lines of the magnetic component 22, it can convert kinetic energy into the electrical energy and store in the energy storage device 60 and supply the power to the lighting member 24 by the energy storage component 60. By such arrangement, the operator can open the function component 1002 anytime and ensure supply of electricity via the energy storage component 60 anytime, such that, when the vacuum cleaner is used, it can open the lighting member 24 to light anytime as required.

Furthermore, the energy storage component 60 is located between the magnetic component 22 and the function component 1002, facilitating to being connected to the magnetic component 22 and the function component 1002.

Furthermore, the energy storage component 60 of the present embodiment can be provided with a charging socket (not shown), and when the electricity converted by the power generation unit 20A is not sufficient, the energy storage component 60 can be supplied power from external environment.

In some embodiments, such as a sixth embodiment, a seventh embodiment and an eighth embodiment, the lighting assembly 20 can be detachably installed in the housing 10 to enable the lighting assembly 20 to have a working state and a non-working state. At the working state, a movable component 23 can move under a suction force of a vacuum cleaner and cut magnetic induction lines generated of a magnetic component 22, and the power generation unit 20A can supply sufficient electricity to the lighting member 24 to enable the lighting member 24 to light. At the non-working state, the movable component 23 can not be driven by the suction force of the vacuum cleaner or can merely slowly move under the suction force of the vacuum cleaner, the power generation unit 20A can not supply sufficient power to the lighting member 24, the lighting member 24 can not light, and the power generation unit 20A can not supply power to the lighting member 24.

By such arrangement, even during an operation of the vacuum cleaner, whether the lighting assembly 20 lights or not can be adjusted, thereby, a use method is more flexible.

Referring to FIGS. 27 to 40, in the sixth embodiment, a rotor 231 is provided on a side of the magnetic component 22 towards the fluid port 11, a cover 21 can be liftably installed on a first through hole 13, and a lifting direction of the cover 21 is shown as a of the FIGS. 30 and 40. The lighting assembly 20 can be at a first extreme position I and a second extreme position II. When the lighting assembly 20 is at the first extreme position I, at least part of the lighting assembly 20 is located in a housing 10 to be in the working state. When the lighting assembly 20 is at the second extreme position II, at least part of the lighting assembly 20 is located out of the housing 10 to be in the non-working state.

When the lighting assembly 20 is at the first extreme position I, at least part of the lighting assembly 20 is located in the housing 10, at least part of the air inlet 211 or the air outlet 212 is located in the housing 10, such that sufficient suction force can act on the movable component 23, and the movable component 23 can generate sufficient power to enable the lighting member 24 to light. When the lighting assembly 20 is at the second extreme position II, at least part of the lighting assembly 20 is located outside the housing 10, such that the suction force is not sufficient to act on the movable component 23, and the movable component 23 can not generate sufficient electricity to enable the lighting member 24 to light.

Furthermore, a side of the cover 21 towards the fluid port 11 is provided with a ventilation portion 213 and a sealing portion 214 stacked along a lifting direction of the cover 21, and the air inlet 211 is located on the ventilation portion 213. When the auxiliary assembly 1001 is in the working state, the ventilation portion 213 and the sealing portion 214 are both located in the housing 10. When the auxiliary assembly 1001 is in the non-working state, the sealing portion 214 is located in the housing 10, and the ventilation portion 213 moves outside the housing 10 through the first through hole 13.

In the present embodiment, the cover 21 includes a first stopping ridge 215 and a second stopping ridge 216. Sizes of the first stopping ridge 215 and the second stopping ridge 216 are both greater than that of the first through hole 13. The first stopping ridge 215 is located on a side of the cover 21 towards the lighting member 24 and out of the housing 10, and the second stopping ridge 216 is located between the ventilation portion 213 and the sealing portion 214 and located in the housing 10. By such arrangement, the first extreme position I and the second extreme position II of the lighting assembly 20 can be defined by the first stopping ridge 215 and the second stopping ridge 216.

In the present embodiment, the first stopping ridge 215 and the second stopping ridge 216 are both in a ring shape, in other embodiments (not shown), the first stopping ridge 215 and the second stopping ridge 216 can be in other non-ring shapes, as long as the first stopping ridge 215 and the second stopping ridge 216 can be a stopping effect.

Referring to FIGS. 27, 29, 30, 31, 36, 39 and 40, the dust suction head 100 further includes a first switching component 31, and the first switching component 31 can be flexibly installed in the housing 10. The lighting assembly 20 further includes a cover 21 and a first elastic component 25. The magnetic component 22 and the movable component 23 are both disposed in the cover 21. The lighting member 24 is installed in the cover 21. A first abutting block 217 protrudes from the cover 21. The first elastic component 25 is elastic along a lifting direction a of the cover 21. The first elastic component 25 abuts against the first abutting block 217. The first elastic component 25 enables the lighting assembly 20 to have a tendency to switch to the non-working state, the first switching component 31 is configured to enable the lighting assembly 20 to be positioned in the working state and give way when the lighting assembly 20 is switched to the non-working state. In the present embodiment, when the lighting assembly 20 is at the first extreme position I, the first switching component 31 abuts against and is restricted by the first stopping ridge 215 to locate the lighting assembly 20 to the working state.

In other embodiments (not shown), the first elastic component 25 is not required, the lighting assembly 20 can be switched between the working state and the non-working state by an external force, and the lighting assembly 20 is located at the first extreme position I or the second extreme position II by a snapping structure. In addition, in other embodiments (not shown), the first elastic component 25 can enable the lighting assembly 20 to have a tendency to switch to the working state, and the first switching component 31 is configured to enable the lighting assembly 20 to be positioned in the non-working state and give way when the lighting assembly 20 is switched to the working state.

In particular, referring to FIG. 39, the dust suction head 100 further includes two guiding seats 50, the two guiding seats 50 are fixed on two side walls of the housing 10 opposite to each other and protrude inwards the dust suction head 100. Two accommodating grooves 51 are formed between the two guiding seats 50 and the housing 10, and a side of each of two guiding seats 50 towards an inner part of the dust suction head 100 is provided with an avoidance slot 52 along the lifting direction a of the cover 21. The number of the first elastic component 25 and the first abutting block 217 are both two. Two first abutting blocks 217 protrude from two sides of the cover 21, respectively. The two first abutting blocks 217 are inserted in to the accommodating groove 51. The two first elastic components 25 are accommodated in the accommodating groove 51, and each of the two first elastic components 25 corresponds to one of two first abutting blocks 217.

Furthermore, the dust suction head 100 further includes a second elastic component 32. A second abutting block 15 protrudes from an outer wall of the housing 10. The second elastic component 32 is disposed between the second abutting block 15 and the first switching component 31. The first switching component 31 is slidably installed on the second abutting block 15 and capable of being in contact with or separated from the cover 21, and a certain incline angle is defined between a sliding direction y of the first switching component 31 and the lifting direction a of the cover 21. The second elastic component 32 can exert the elastic force to the first switching component 31 to enable the first switching component 31 to have a tendency to abut against the cover 21 continuously.

In the present embodiment, the sliding direction y of the second elastic component 32 is consist with that of the first switching component 31 and parallel to a surface of the housing 10 corresponding to the first switching component 31. A direction of the elastic force of the second elastic component 32 and the sliding direction y of the first switching component 31 are both perpendicular to the lifting direction a of the cover 21.

In some embodiments (not shown), the second elastic component 32 is not required. The first switching component 31 can fix the lighting assembly 20 at the first extreme position I or the second extreme position II by a lock, a snap, a buckle, and so on.

In the sixth embodiment, a process of the vacuum cleaner head 100 switching from the working state to the non-working state is as follows. Under an external force, the first switching component 31 moves away from the first stopping ridge 215 and compresses the second elastic component 32 until the first switching component 31 leaves the first stopping ridge 215. At this moment, under an elastic force of the first elastic component 25, the first abutting block 217 moves from the first extreme position I to the second extreme position II until the second stopping ridge 216 abuts against the inner wall of the housing 10 and reaches to the second extreme position II. At this moment, a part of the air inlet 211 is located outside the housing 10 or the air inlet 211 is totally located outside the housing 10, the movable component 23 neither acquire sufficient kinetic energy nor generate sufficient electricity energy to supply power to the lighting member 24, such that the dust suction head 100 is switched from the working state to the non-working state.

A process of the vacuum cleaner head 100 switching from the non-working state to the working state is as follows. Under the external force, the cover 21 moves from the second extreme position II to the first extreme position I. The first switching component 31 moves away from the first stopping ridge 215 and compresses the second elastic component 32 to give way to the first stopping ridge 215 under the external force. When the cover 21 moves until the first stopping ridge 215 is in contact with the housing 10, the external force on the first switching component 31 is withdrawn, the first switching component 31 is reset to a state that the first switching component 31 abuts against and is restricted by the first stopping ridge 215 (i.e., the first extreme position I) under the elastic force of the second elastic component 32. At this time, a part of the air inlet 211 is located in a cavity of the housing 10 or the air inlet 211 is totally located in a cavity of the housing 10, the movable component 23 acquires sufficient kinetic power and generates sufficient electricity energy to supply the power to the lighting member 24, such that the dust suction head 100 switches from the non-working state to the working state.

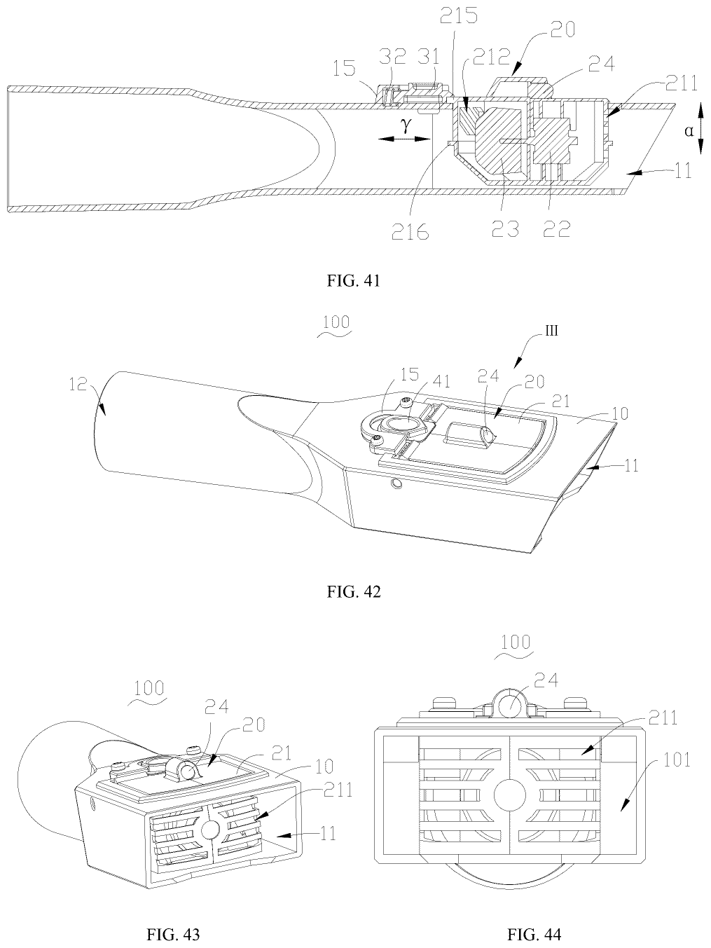

Referring to FIG. 41, the seventh embodiment is substantially the same as the sixth embodiment, except that, in the seventh embodiment, a rotor 231 is provided on a side of the magnetic component 22 away from the fluid port 11 to prevent the rotor 231 from facing the dust.

In other embodiments shown or not shown, the rotor 231 can be disposed on a side of the magnetic component 22 away from the fluid port 11, which is not limited herein.

Referring to FIGS. 42 to 53, in the eighth embodiment, a cover 21 can be rotatably installed on a first through hole 13, and the rotation direction is shown as B direction in FIGS. 46 and 53. The lighting assembly 20 includes a third extreme position III and a fourth extreme position IV. At the third extreme position III, at least part of the lighting assembly 20 is located in a housing 10 to form the working state. At the fourth extreme position IV, at least part of the lighting assembly 20 is located out of the housing 10 to form the non-working state.

At the third extreme position III, at least part of the lighting assembly 20 is located in the housing 10, at least part of the air inlet 211 or the air outlet 212 is located in the housing 10, such that a sufficient suction force can act on a movable component 23, and the movable component 23 can generate sufficient power to enable the lighting member 24 to light. At the fourth extreme position IV, at least part of the lighting assembly 20 is located outside the housing 10, at least part of the air inlet 211 or the air outlet 212 is located outside the housing 10, the suction force is not sufficient to act on the movable component 23, and the movable component 23 can not generate sufficient power to enable the lighting member 24 to light.

A dust suction head 100 further includes a second switching component 41. The second switching component 41 can be flexibly installed in the housing 10. The lighting assembly 20 further includes a third elastic component 42, and the third elastic component 42 elastically abuts against the cover 21 and the second switching component 41. The third elastic component 42 enables the lighting assembly 20 to have a tendency to switch to the non-working state, and the second switching component 41 is configured to enable the lighting assembly 20 to be positioned in the working state and give way when the lighting assembly 20 is switched to the non-working state.

In particular, the third elastic component 42 can be a torsional spring.

In other embodiments (not shown), the third elastic component 42 is not required, the lighting assembly 20 can be switched between the working state and the non-working state under the external force. In addition, the third elastic component 42 can enable the lighting assembly 20 to have a tendency to switch to the working state, the second switching component 41 is configured to enable the lighting assembly 20 to be positioned in the non-working state and give way when the lighting assembly 20 is switched to the working state, which is not limited herein.

The dust suction head 100 further includes a second elastic component 32. A second abutting block 15 protrudes from an outer wall of the housing 10. The second elastic component 32 is disposed between the second abutting block 15 and the second switching component 41. The second switching component 41 can be slidably installed on the second abutting block 15 and capable of being in contact with or separated from the cover 21. The second elastic component 32 can exert the elastic force to the second switching component 41 to enable the second switching component 41 to have a tendency to continuously abut against the cover 21. In the present embodiment, a sliding direction y of the second switching component 41 is parallel to an axis of the dust suction head 100, which is shown in FIGS. 46 and 53.

A maximum rotation range of the cover 21 relative to the housing 10 is 15° to 90°. Alternatively, a maximum rotation range of the cover 21 relative to the housing 10 is 30° to 60°.

In the eighth embodiment, a process of the dust suction head 100 switching from the working state to the non-working state is as follows. Under the external force, the second switching component 41 moves away from the cover 21 and compresses the second elastic component 32 until the second switching component 41 is separated from the cover 21. At this moment, under an elastic force of the third elastic component 42, the cover 21 moves from the third extreme position III to the fourth extreme position IV until the cover rotates to the fourth extreme position IV, at this moment, a part of the air inlet 211 is located outside of the housing 10 or the air inlet 211 is totally located outside of the housing 10, the movable component 23 neither acquire sufficient kinetic energy nor generate sufficient electricity to supply power to the lighting member 24, such that the dust suction head 100 is switched form the working state to the non-working state.

A process of the dust suction head 100 switching from the non-working state to the working state is as follows. Under the external force of the cover 21, the cover 21 moves from the fourth extreme position IV to the third extreme position III. The second switching component 41 is reset to a state where the second switching component 41 abuts against and is restricted by the cover 21 (i.e., the third extreme position III) under the elastic force of the second elastic component 32, at this moment, the part of the air inlet 211 is located in the cavity of the housing 10 and the air inlet 211 is totally located in the cavity of the housing 10, the movable component 23 can acquire the sufficient kinetic energy and generate the sufficient electricity energy to the lighting member 24, and the dust suction head 100 switches from the non-working state to the working state.

Furthermore, in some embodiments, such as a ninth embodiment, an auxiliary assembly 100 can be detachably connected to a housing 10.

Referring to FIGS. 54 and 55, a structure of a dust suction head 100 in the ninth embodiment is substantially the same as that of the dust suction head in the fourth embodiment, the difference is in that in the ninth embodiment, a lighting assembly 20 can be movably installed on the housing 10. By such arrangement, when the lighting assembly 20 is not required or the lighting assembly 20 is required to be maintained or replaced, the overall lighting assembly 20 can be detached from the housing 10. Furthermore, the lighting assembly 20 can be movably installed on the housing 10, which is conducive to replacing the lighting assembly 20 to the auxiliary assembly 1001 with other functions.

In the present embodiment, the dust suction head 100 further includes a sealing cover 70. The sealing cover 70 is detachably snapped on the housing 10 where a first through hole 13 is located, which is configured to seal the first through hole 13 after removing the auxiliary assembly 1001, thereby preventing dust or impurities from entering the housing 10. Meanwhile, the sealing cover 70 can play a role of sealing to prevent a suction function of the dust suction head 100 from affecting after the lighting assembly 20 is removed.

In particular, referring to FIG. 55, two opposite sides of an inner wall of the housing 10 where the first through hole 13 is located is provided with a first snapping portion 16 and a second snapping portion 17. The sealing cover 70 is provided with an elastic snapping component 71 configured to be snapped with the first snapping portion 16 and the second snapping portion 17. The sealing cover 70 is elastically snapped on the first through hole 13 of the housing 10 by the elastic snapping component 71.

Furthermore, in order to prevent from losing the sealing cover 70, the sealing cover 70 can be stored on an outer wall of the housing 10 by hanging ropes or storage slots formed on the housing 10.

In particular, in the ninth embodiment, the auxiliary assembly 1001 can be detachably embedded into the housing 10. In other embodiments, as long as it does not affect the auxiliary assembly 1001, the auxiliary assembly 1001 can be detachably sleeved on the housing 10, including but not limit by being sleeved on a middle of the housing 10 or the fluid port 11 of the housing 10.

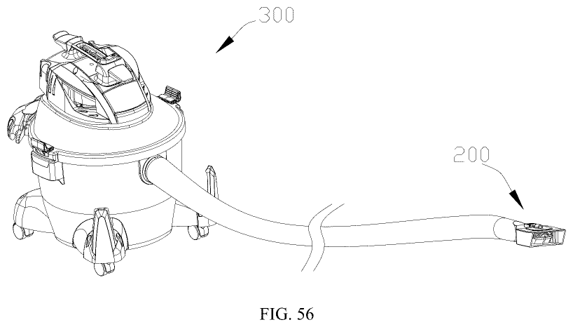

Referring to FIG. 56, the present disclosure further provides an electric tool 300 including a tool fitting 200 for the using process having the fluid flowing.

Alternatively, the electric tool 300 can be a vacuum cleaner.

In the present disclosure, a vacuum cleaner can enable the lighting member 24 of the dust suction head 100 to light via a suction force generated by the vacuum cleaner, which is conducive for the operator to observe a gloomy corner.

The various technical features of the above embodiments can be combined in any way. In order to make the description concise, not all possible combinations of the various technical features in the above embodiments have been described. However, as long as there is no contradiction in the combination of these technical features, they should be considered within the scope of the specification.

Ordinary skill in the art should recognize that the above embodiments are only used to illustrate the present disclosure, and not to limit the present disclosure. Any appropriate changes and variations made to the above embodiments within the substantive spirit of the present application fall within the scope of protection claimed by the present disclosure.

What is claimed is:

1. A tool fitting with fluid based electricity generation comprising:
a housing provided with a fluid port; and
an auxiliary assembly installed on the housing,
wherein the auxiliary assembly comprises a power generation unit and a function component, the function component is electrically connected to the power generation unit, the power generation unit is capable of converting kinetic energy into electrical energy under flowing of a fluid and supplying power to the function component.

2. The tool fitting of claim 1, wherein the power generation unit comprises a magnetic component and a movable component, the function component is electrically connected to the movable component, and the movable component is capable of moving and cutting magnetic induction lines generated by the magnetic component under flowing of the fluid.

3. The tool fitting of claim 2, wherein the movable component comprises a rotor and the rotor is capable of rotating and cutting the magnetic induction lines generated by the magnetic component under flowing of the fluid.

4. The tool fitting of claim 2, wherein the auxiliary assembly is movably installed on the housing to enable the auxiliary assembly to have a working state or a non-working state;
when the auxiliary assembly is in the working state, the movable component is capable of being driven to move and cutting the magnetic induction lines generated by the magnetic component under flowing of the fluid, the power generation unit is capable of supplying an sufficient electricity to the function component to enable the function component to be in operation; and
when the auxiliary assembly is in the non-working state, the movable component is not capable of being driven to move by flowing of the fluid or the movable component is capable of being driven to move slowly by flowing of the fluid, the power generation unit is not capable of supplying sufficient electricity to the function component, and the function component is out of operation.

5. The tool fitting of claim 4, wherein the auxiliary assembly further comprises a cover, the magnetic component and the movable component are disposed in the cover, the function component is installed in the cover;
the housing is provided with a first through hole, the cover is liftably installed on the first through hole, the auxiliary assembly is capable to be at a first extreme position and a second extreme position;
when the auxiliary assembly is at the first extreme position, at least part of the auxiliary assembly is located in the housing to be in the working state; and
when the auxiliary assembly is at the second extreme position, at least part of the auxiliary assembly is located out of the housing to be in the non-working state.

6. The tool fitting of claim 5, wherein the cover is provided with an air inlet and an air outlet, the air inlet is located on a side of the cover towards the fluid port, and the air outlet is located on a side of the cover away from the fluid port.

7. The tool fitting of claim 6, wherein a ventilation portion and a sealing portion stacked up along a lifting direction of the cover are provided on a side of the cover towards the fluid port, the air inlet is located on the ventilation portion;
when the auxiliary assembly is in the working state, the ventilation portion and the sealing portion are located in the housing; and
when the auxiliary assembly is in the non-working state, the sealing portion is located in the housing, the ventilation portion is capable of moving out of the housing through the first through hole.

8. The tool fitting of claim 7, wherein the cover comprises a first stopping ridge and a second stopping ridge, sizes of the first stopping ridge and the second stopping ridge are both greater than that of the first through hole; and
the first stopping ridge is located on a side of the cover towards the function component, the first stopping ridge is located outside the housing, the second stopping ridge is located between the ventilation portion and the sealing portion, and the second stopping ridge is located in the housing.

9. The tool fitting of claim 5, wherein the tool fitting further comprises a first switching component, the first switching component is movably installed on the housing; the auxiliary assembly further comprises a cover and a first elastic component, the magnetic component and the movable component are both disposed in the housing, the function component is installed on the cover; the cover is provided with a first abutting block protruding from the cover, the first elastic component is elastic along the lifting direction of the cover, the first elastic component abuts against the first abutting block;
the first elastic component is capable of enabling the auxiliary assembly to have a tendency to switch to the working state, the first switching component is configured to enable the auxiliary assembly to be positioned in the non-working state and give way when the auxiliary assembly is switched to the working state; or, the first elastic component is capable of enabling the auxiliary assembly to have a tendency to switch to the non-working state, the first switching component is configured to enable the auxiliary assembly to be positioned in the working state and give way when the auxiliary assembly is switched to the non-working state.

10. The tool fitting of claim 9, wherein the tool fitting further comprises two guiding seats, the two guiding seats are fixed on two sidewalls of the housing opposite to each other, respectively, the two guiding seats protrudes inwards the tool fitting, two accommodating grooves are formed between the two guiding seats and the housing, a side of each of the two guiding seats towards inside the tool fitting is provided with an avoidance slot along the lifting direction of the cover;
the first elastic component and the first abutting block are both set as two, two first abutting blocks protrude from two sides of the cover, respectively; and
the two first abutting blocks are inserted into the two accommodating grooves from the avoidance slot, two first elastic components are accommodated in the two accommodating grooves, each of the two first elastic components corresponds to one of the two first abutting blocks; and/or
the tool fitting comprises a second elastic component, wherein a second abutting block protrudes from an outer wall of the housing, the second elastic component is disposed between the second abutting block and the first switching component, the first switching component is slidably installed on the second abutting block and capable of being in contact with or separated from the cover, an incline angle is defined between a sliding direction of the first switching component and the lifting direction of the cover; and
the second elastic component is capable of exerting an elastic force to the first switching component, such that the first switching component has a tendency to abut against the cover continuously.

11. The tool fitting of claim 4, wherein the auxiliary assembly further comprises a cover, the magnetic component and the movable component are disposed in the cover, the function component is installed in the cover; the housing is provided with a first through hole, the housing is rotatably installed on the first through hole, the auxiliary assembly is capable to be at a third extreme position and a fourth extreme position;
when the auxiliary assembly is at the third extreme position, at least part of the auxiliary assembly is located in the housing to be in the working state; and
when the auxiliary assembly is at the fourth extreme position, at least part of the auxiliary assembly is located out of the housing to be in the non-working state.

12. The tool fitting of claim 11, further comprising a second switching component, wherein the second switching component is movably installed on the housing; the auxiliary assembly further comprises a third elastic component, the third elastic component abuts against the cover and the second switching component; and
the third elastic component is capable of enabling the auxiliary assembly to have a tendency to switch to the working state, the second switching component is configured to enable the auxiliary assembly to be positioned in the non-working state and give way when the auxiliary assembly is switched to the working state; or the third elastic component is capable of enabling the auxiliary assembly to have a tendency to switch to the non-working state, the second switching component is configured to enable the auxiliary assembly to be positioned in the working state and give way when the auxiliary assembly is switched to the non-working state.

13. The tool fitting of claim 12, further comprising a second elastic component, wherein the second abutting block protrudes from an outer wall of the housing, the second elastic component is provided between the second abutting block and the second switching component, the second switching component is slidably installed on the second abutting block and capable of being in contact with or separated from the cover; and
the second elastic component is capable of exerting an elastic force to the second switching component to enable the second switching component to have a tendency to abut against the cover continuously.

14. The tool fitting of claim 11, wherein the cover is provided with an air inlet and an air outlet, the air inlet is located on a side of the cover towards the fluid port, the air outlet is formed on a side of the cover away from the fluid port; and/or
a rotation angle of the cover relative to the housing is in a range of 15° to 90°.

15. The tool fitting of claim 4, wherein the auxiliary assembly is a lighting assembly, the function component is a lighting member; the lighting assembly is movably installed on the housing, such that the lighting assembly has the working state and the non-working state;
when the lighting assembly is in the working state, the movable component is capable of being driven to move and cutting the magnetic lines generated by the magnetic component under flowing of the fluid, the power generation unit is capable of supplying the sufficient electricity to the lighting member to enable the lighting member to light; and
when the lighting assembly is in the non-working state, the movable component is not capable of being driven to move by flowing of the fluid, or the movable component is capable of being driven to move slowly under flowing of the fluid, the power generation unit is not capable of supplying sufficient electricity to the lighting member, such that the lighting member is not able to light;
and/or
the auxiliary assembly is detachably connected to the housing.

16. The tool fitting of claim 3, wherein the auxiliary assembly further comprises a cover, the cover is fixed on the cover, the cover is provided with an air inlet and an air outlet, the magnetic component and the movable component are both disposed in the cover, and the function component is installed in the housing.

17. The tool fitting of claim 16, wherein the auxiliary assembly further comprises a dust cover, the dust cover is disposed on a side of the cover towards the fluid port; and
the air inlet is located on a side of the cover towards the fluid port, and the air outlet is located on a side surface of the cover.

18. The tool fitting of claim 16, wherein a ventilation portion and a sealing portion are provided on a side of the cover towards the fluid port, the sealing portion is disposed in the fluid port, the ventilation portion is located outside the housing; the air outlet is located on a side of the fluid port and/or a side surface of the cover; or
the cover comprises a convex portion and a main portion fitting with each other, the convex portion is disposed outside the housing, the main portion is disposed in the housing, the air inlet is located on the convex portion, the air outlet is located on a side of the main portion away from the fluid port or a side surface of the main portion; and/or
the rotor is disposed on a side of the magnetic component towards the fluid port; or
the rotor is disposed on a side of the magnetic component away from the fluid port.

19. The tool fitting of claim 1, wherein the tool fitting further comprises an energy storage component and the energy storage component is electrically connected to the function component to supply power to the function component;
the energy storage component is further electrically connected to the power generation unit and capable of storing electrical energy converted by the power generation unit to supply the power to the function component; and/or
the energy storage component is detachably connected to the housing; and/or the energy storage component is a disposable battery or a rechargeable battery.

20. An electric tool, comprising the tool fitting of claim 1.
